(19) United States
(12) Patent Application Publication
(10) Pub. No.: US 2025/0102969 A1
(43) Pub. Date: Mar. 27, 2025

(54) FIXING DEVICE AND IMAGE FORMING APPARATUS

(71) Applicant: FUJIFILM BUSINESS INNOVATION CORP., Tokyo (JP)

(72) Inventors: Hideki SATO, Kanagawa (JP); Sou MORIZAKI, Kanagawa (JP)

(73) Assignee: FUJIFILM BUSINESS INNOVATION CORP., Tokyo (JP)

(21) Appl. No.: 18/587,137

(22) Filed: Feb. 26, 2024

(30) Foreign Application Priority Data
Sep. 27, 2023 (JP) 2023-164223

(51) Int. Cl. G03G 15/20

(52) U.S. Cl. CPC G03G 15/2017; G03G 15/206; G03G 15/2064; G03G 2215/2035

(57) ABSTRACT

A fixing device includes: an endless belt; a fixing section that forms a fixing nip by being in contact with the belt; and a pressing section that is disposed inside of the belt, has a shape following an outer peripheral shape of the fixing section, includes a holding portion that holds an elastic member, and presses the belt against the fixing section. The elastic member has a shape along the holding portion due to deformation in a state of not being pressed against the fixing section.

### CROSS-REFERENCE TO RELATED APPLICATIONS

This application is based on and claims priority under 35 USC 119 from Japanese Patent Application No. 2023-164223 filed Sep. 27, 2023.

### BACKGROUND

### (i) Technical Field

The present disclosure relates to a fixing device and an image forming apparatus.

### (ii) Related Art

To date, as a technology related to a fixing device, for example, a technology disclosed in Japanese Unexamined Patent Application Publication No. 2016-188916 or the like has been already proposed.

In the technology described in Japanese Unexamined Patent Application Publication No. 2016-188916, a surface of a nip forming member on the fixing nip side is a surface of a metal member, a gap is formed further outside than an outer end of an end region of the metal member in a longitudinal direction, the end region being a sheet-passing region of a maximum-sized sheet that can pass, and a vertical side of the gap extends so as to be inclined with respect to a belt rotation direction.

### SUMMARY

Aspects of non-limiting embodiments of the present disclosure relate to enabling a sheet-shaped member having a uniform thickness to be used as an elastic member and achieving reduction in manufacturing cost compared with a case where a sheet-shaped member having a non-uniform thickness is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: an endless belt; a fixing section that forms a fixing nip by being in contact with the belt; and a pressing section that includes a holding portion that is disposed inside of the belt, has a shape following an outer peripheral shape of the fixing section, and holds an elastic member, and the pressing section pressing the belt against the fixing section. The elastic member has a shape along the holding portion due to deformation in a state of not being pressed against the fixing section.

### BRIEF DESCRIPTION OF THE DRAWINGS

Exemplary embodiments of the present disclosure will be described in detail based on the following figures, wherein:

FIG. 1 is an overall view of an image forming apparatus including a fixing device according to a first exemplary embodiment of the present disclosure;

FIG. 2 is a sectional view of the fixing device according to the first exemplary embodiment of the present disclosure;

FIG. 3 is a sectional view of a part of the fixing device according to the first exemplary embodiment of the present disclosure;

FIG. 4 is a side view of a pressing member;

FIG. 5 is a sectional view of a fixing device of the related art;

FIG. 6 is a perspective view of a part of the fixing device according to the first exemplary embodiment of the present disclosure;

FIG. 7 is a perspective view of another part of the fixing device according to the first exemplary embodiment of the present disclosure;

FIG. 8 is a side view of another example of a pressing member of the fixing device according to the first exemplary embodiment of the present disclosure;

FIG. 9 is a perspective view of the other example of the pressing member of the fixing device according to the first exemplary embodiment of the present disclosure;

FIG. 10 is a graph representing a pressure distribution of the fixing device according to the first exemplary embodiment of the present disclosure; and

FIG. 11 is a graph representing a pressure distribution of the fixing device according to the first exemplary embodiment of the present disclosure.

### DETAILED DESCRIPTION

Hereafter, exemplary embodiments of the present disclosure will be described with reference to the drawings.

### First Exemplary Embodiment

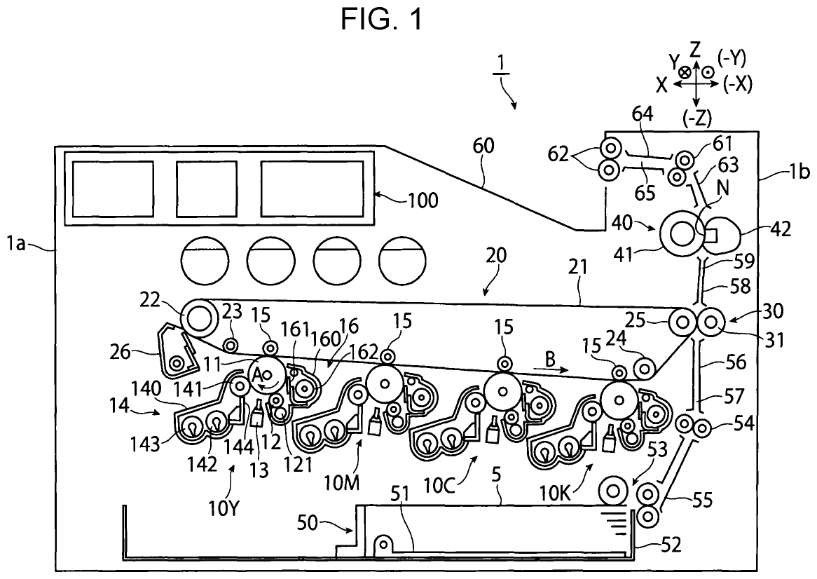

FIG. 1 is an overall view of an image forming apparatus 1 including a fixing device according to a first exemplary embodiment of the present disclosure. In FIG. 1, “X” indicates the horizontal direction (width direction) of the image forming apparatus, “Y” indicates the depth direction of the image forming apparatus, and “Z” indicates the vertical direction of the image forming apparatus.

### Overall Configuration of Image Forming Apparatus

The image forming apparatus 1 is, for example, a color printer. As illustrated in FIG. 1, the image forming apparatus 1 includes plural image forming devices 10, an intermediate transfer device 20, a sheet-feeding device 50, a fixing device 40 as an example of a fixing section according to the first exemplary embodiment, and the like. The plural image forming devices 10 form toner images developed with toners included in developers. The intermediate transfer device 20 holds the toner images formed by the image forming devices 10 and transports the toner images to a second transfer position where the toner images are finally second-transferred to a recording sheet 5 as an example of a recording medium. The sheet-feeding device 50 contains and transports a desirable recording sheets 5 to be supplied to the second transfer position of the intermediate transfer device 20. The fixing device 40 fixes, onto the recording sheet 5, the toner images (each an example of an image) that have been second-transferred by the intermediate transfer device 20. An apparatus body 1a illustrated in FIG. 1 includes a supporting structure member, an outer cover, and the like.

In the first exemplary embodiment, the plural image forming devices 10 and the intermediate transfer device 20 constitute an image forming section that forms a toner image on a recording medium. The image forming section may include a single image forming device and directly form a toner image on a recording medium without using an intermediate transfer device.

The image forming device 10 includes four image forming devices 10Y, 10M, 10C, and 10K that respectively and dedicatedly form yellow (Y), magenta (M), cyan (C) and black (K) toner images. The four image forming devices 10 (Y, M, C, K) are arranged in a row in a horizontal direction X in an inner space of the apparatus body 1a.

As illustrated in FIG. 1, each of the image forming devices 10 (Y, M, C, K) includes a photoconductor drum 11 as an example of an image holding section that rotates. The following devices are disposed around the photoconductor drum 11. The devices are a charger 12, an exposure device 13, a developing device 14, a first transfer device 15, a drum cleaning device 16, and the like. The charger 12 charges a peripheral surface (image-holding surface) of the photoconductor drum 11, on which an image can be formed, to a desirable potential. The exposure device 13 forms an electrostatic latent image (for each color) having a potential difference on the charged peripheral surface of the photoconductor drum 11 by irradiating the peripheral surface with light based on information (signal) of an image. The developing device 14 forms a toner image by developing the electrostatic latent image with a toner of a corresponding color (Y, M, C, K). The first transfer device 15 transfers the toner image to the intermediate transfer device 20. The drum cleaning device 16 performs cleaning by removing substances such as toner adhering to the image-holding surface of the photoconductor drum 11 after first transfer has been finished. Numerals indicating the photoconductor drum 11, the charger 12, and the like are attached to only the image forming device 10Y of yellow (Y) and omitted for the other image forming devices 10 (M, C, K).

The photoconductor drum 11 includes a hollow cylindrical or solid cylindrical base member that is grounded and that has an image-holding surface having a photoconductive layer (photosensitive layer), made of a photosensitive material, formed on the periphery thereof. The photoconductor drum 11 is supported so as to be rotated in the direction of an arrow A by a driving force transmitted from a driving device (not shown).

The charger 12 includes a contact-type charging roller that is disposed in contact with the photoconductor drum 11. A charging voltage is supplied to the charger 12. As the charging voltage, in a case where the developing device 14 is a device that performs reversal development, a voltage or a current having the same polarity as the charged polarity of toner supplied from the developing device 14 is supplied. On the back side of the charger 12, a cleaning roller 121 that cleans the surface the charger 12 is disposed in contact with the charger 12.

The exposure device 13 includes an LED (light emitting diode) print head that forms an electrostatic latent image by irradiating the photoconductor drum 11 with light emitted in accordance with image information from LEDs as plural light-emitting elements that are arranged in the axial direction of the photoconductor drum 11, and the like. Information (signal) of an image, which is input to the image forming apparatus 1 in any appropriate way, is sent to the exposure device 13 at the time of forming a latent image. As the exposure device 13, a device that forms an electrostatic latent image by irradiating the charged peripheral surface of the photoconductor drum 11 with a laser beam emitted in accordance with information of an image input to the image forming apparatus 1 may be used.

As illustrated in FIG. 1, each of the developing devices 14 includes, inside of a housing 140 having an opening and a developer-containing chamber, a development roller 141, agitation transport members 142 and 143, a thickness-regulating member 144, and the like. The development roller 141 holds a developer and transports the developer to a development region where the development roller 141 faces the photoconductor drum 11. The agitation transport members 142 and 143 each include a screw auger that transports the developer to pass through the development roller 141 while agitating the developer, and the like. The thickness-regulating member 144 regulates the amount (layer thickness) of the developer held by the development roller 141. To the developing device 14, a developing voltage is supplied between the development roller 141 and the photoconductor drum 11 from a power supply (not shown). The development roller 141 and the agitation transport members 142 and 143 rotate in desirable directions as driving forces are transmitted from driving devices (not shown). As the developer for each of the four colors, a two-component developer including a nonmagnetic toner and a magnetic carrier is used.

As illustrated in FIG. 1, the first transfer device 15 is a contact-type transfer device including a first transfer roller that rotates in contact with the peripheral surface of the photoconductor drum 11 with an intermediate transfer belt 21 therebetween and to which a first transfer voltage is supplied. As the first transfer voltage, a direct-current voltage having a polarity opposite to the charged polarity of toner is supplied from a power supply (not shown).

The drum cleaning device 16 includes a cleaning blade 161, a feed-out member 162, and the like that are disposed inside of a body 160 having a container-like shape. The cleaning blade 161 performs cleaning by removing adherents such as remaining toner. The feed-out member 162 includes a screw auger that recovers adherents such as toner removed by the cleaning blade 161 and transports the adherents to a recovery system (not shown).

The intermediate transfer device 20 is disposed at a position above the image forming devices 10 (Y, M, C, K) in the vertical direction Z. The intermediate transfer device 20 includes the intermediate transfer belt 21, plural belt support rollers 22 to 25, a belt cleaning device 26, and a second transfer device 30. The intermediate transfer belt 21 is an example of an intermediate transfer section that moves in a circulatory manner in the direction of an arrow B while passing through a first transfer position between the photoconductor drum 11 and the first transfer device 15 (first transfer roller). The plural belt support rollers 22 to 25 hold the intermediate transfer belt 21 to be in a desirable state from the inside thereof so that the intermediate transfer belt 21 can move in a circulatory manner. The second transfer device 30 is disposed on the outer peripheral surface (image-holding surface) side of the intermediate transfer belt 21, which is supported by the belt support roller 25, and second-transfers the toner image on the intermediate transfer belt 21 to the recording sheet 5. The belt cleaning device 26 performs cleaning by removing adherents such as toner and paper dust remaining on the outer peripheral surface of the intermediate transfer belt 21 after passing through the second transfer device 30.

As the intermediate transfer belt 21, an endless belt made of a material in which a resistance adjusting agent such as carbon black is dispersed in a resin, such as polyimide resin, polyamide resin, or polyamideimide resin, is used. The belt support roller 22 is a driving roller. The belt support roller 23 is a surface-forming roller that holds the running position of the intermediate transfer belt 21. The belt support roller 24 is a tension roller that applies a tension to the intermediate transfer belt 21. The belt support roller 25 is a backup roller of second transfer.

The second transfer device 30 includes a second transfer roller 31 that rotates at a second transfer position. The second transfer position is an outer peripheral surface part of the intermediate transfer belt 21 supported by the belt support roller 25 of the intermediate transfer device 20. To the second transfer roller 31 or the belt support roller 25 of the intermediate transfer device 20, a direct-current voltage having a polarity opposite to or the same as the polarity of toner is suppled as a second transfer voltage.

The fixing device 40 includes a pressing belt 42 as an example of an endless belt and a heating roller 41 as an example of a fixing section that forms a fixing nip N by being in contact with the pressing belt 42. The heating roller 41 is heated by a heater so that the surface temperature thereof is maintained at a predetermined temperature. The pressing belt 42 rotates while being in contact with the heating roller 41 with a desirable pressure. In the fixing device 40, a contact portion where the heating roller 41 and the pressing belt 42 are in contact with each other is the fixing nip N where a desirable fixing process (heating and pressing) of fixing an unfixed toner image to the recording sheet 5 is performed. The fixing device 40 will be described in detail below.

The sheet-feeding device 50 is disposed at a position below the image forming devices 10 (Y, M, C, K). The sheet-feeding device 50 includes a single (or plural) sheet container(s) 52 and a feeding device 53 that feeds out the recording sheets 5 one by one from the sheet container 52. The sheet container 52 contains the recording sheets 5 of desirable sizes, types, and the like in a state of being stacked on a stack plate 51. The sheet container 52 is attached so that, for example, the sheet container 52 can be drawn out toward the front side of the apparatus body 1a (a side that a user faces during an operation), which is the left side in the example illustrated in the figure.

Examples of the recording sheet 5 include: a plain paper sheet used for an electrophotographic-system copier, printer, or the like; a thin sheet such as a tracing paper sheet; and an OHP sheet that is a transparent film-like medium made of a synthetic resin (such as PET). To further improve the smoothness of an image surface after fixing, it is desirable that the surface of the recording sheet 5 be also as smooth as possible. As the recording sheet 5, for example, a coated paper sheet, which is a plain paper sheet whose surface is coated with a resin or the like, a so-called thick paper sheet having a relatively large basis weight, such as an art paper sheet for printing, or the like may be used.

A sheet feed-transport path 57 is provided between the sheet-feeding device 50 and the second transfer device 30. The sheet feed-transport path 57 includes a single (or plural) sheet transport roller pair(s) 54, which transports the recording sheet 5 fed out from the sheet-feeding device 50 to the second transfer position, and transport guide members 55 and 56. The sheet transport roller pair 54, which is disposed at a position immediately before the second transfer position in the sheet feed-transport path 57, includes, for example, rollers (registration rollers) that adjust the transport timing of the recording sheet 5.

A sheet transport path 59 is provided between the second transfer device 30 and the fixing device 40. The sheet transport path 59 includes a transport guide member 58 and the like that transport the recording sheet 5 fed out from the second transfer device 30 to the fixing device 40.

An output transport path 65 is provided on the downstream side of the fixing device 40. The output transport path 65 includes a sheet transport roller pair 61, a sheet output roller pair 62, transport guide members 63 and 64, and the like, for outputting the recording sheet 5 on which toner images have been fixed by the fixing device 40 to a sheet output unit 60 disposed on an upper part of the apparatus body 1a.

A control device 100, which is an example of a controller, illustrated in FIG. 1 controls the overall operation of the image forming apparatus 1. The control device 100 includes, although not illustrated, a CPU (central processing unit), a ROM (read only memory), a RAM (random access memory), a bus that connects the CPU, the ROM, and the like, a communication interface, and the like.

### Basic Operation of Image Forming Apparatus

Hereafter, a basic image forming operation performed by the image forming apparatus 1 will be described.

Here, an image forming operation of forming a full color image composed of toner images of four colors (Y, M, C, K) by using the four image forming devices 10 (Y, M, C, K) will be described. An image forming operation of forming a monochrome image or an image composed of toner images of plural colors by using one or more of the four image forming devices 10 among the four image forming devices (Y, M, C, K) is basically the same as the one described below.

When the image forming apparatus 1 receives instruction information of a print request, under the control of the control device 100, the four image forming devices 10 (Y, M, C, K), the intermediate transfer device 20, the second transfer device 30, the fixing device 40, and the like start.

Then, in each of the image forming device 10 (Y, M, C, K), first, the photoconductor drum 11 rotates in the direction indicated by the arrow A. The charger 12 charges the surface of the photoconductor drum 11 to a desirable polarity (in the first exemplary embodiment, negative polarity) and potential. Next, the exposure device 13 irradiates the surface of the charged photoconductor drum 11 with light that is emitted based on an image signal obtained by converting information of an image input to the image forming apparatus 1 into each color component (Y, M, C, K). Then, on the surface of the photoconductor drum 11, an electrostatic latent image of a corresponding color component having a desirable potential difference is formed.

Next, each of the developing devices 14 (Y, M, C, K) develops the electrostatic latent image of a corresponding color component formed on the photoconductor drum 11 by supplying toner of a corresponding color (Y, M, C, K), which has been charged to have a desirable polarity (negative polarity), to the electrostatic latent image so that the toner electrostatically adheres to the electrostatic latent image. Due to the development, electrostatic latent images of color components formed on the photoconductor drums 11 are converted into visible images of four colors (Y, M, C, K) respectively developed with toners of the corresponding colors.

Next, the toner images formed on the photoconductor drum 11 of the image forming devices 10 (Y, M, C, K) are transported to the first transfer position. Then, the first transfer device 15 first-transfers the toner images of the colors so as to sequentially overlap each other on the intermediate transfer belt 21 of the intermediate transfer device 20 that rotates in the direction indicated by the arrow B.

In the image forming devices 10 (Y, M, C, K) after first transfer has finished, the drum cleaning device 16 cleans the surface of the photoconductor drum 11 by scraping adherents off the surface. Thus, the image forming devices 10 (Y, M, C, K) become ready to start the next image forming operation.

Next, the intermediate transfer device 20 holds and transports the first-transferred toner images to a second transfer position as the intermediate transfer belt 21 rotates. In synchronism of the image forming operation, the sheet-feeding device 50 feeds a desirable recording sheet 5 to the sheet feed-transport path 57. In the sheet feed-transport path 57, the sheet transport roller pair 54 as a registration roller feeds out the recording sheet 5 to the second transfer position in accordance with a transfer timing.

At the second transfer position, the second transfer roller 31 second-transfers the toner images on the intermediate transfer belt 21 to the recording sheet 5 simultaneously. In the intermediate transfer device 20 after second transfer has finished, the belt cleaning device 26 performs cleaning by removing adherents such as toner remaining on the surface of the intermediate transfer belt 21 after second transfer.

Next, the recording sheet 5, to which the toner images have been second-transferred, is peeled off the intermediate transfer belt 21 and the second transfer roller 31, and then is transported along the sheet transport path 59 to the fixing device 40. The fixing device 40 introduces the recording sheet 5, which holds unfixed toner images after second transfer, into the fixing nip N between the heating roller 41 and the pressing belt 42 that rotate and causes the recording sheet 5 to pass through the fixing nip N. Thus, the fixing device 40 performs a desirable fixing operation (heating and pressing) to fix the toner images to the recording sheet 5. The sheet output roller pair 62 outputs the recording sheet 5, on which fixing has been finished, through the output transport path 65 to the sheet output unit 60 provided on the upper part of the apparatus body 1a.

Through the operation described above, a full color image formed by combining toners of four colors (Y, M, C, K) is output.

### Configuration of Fixing Device

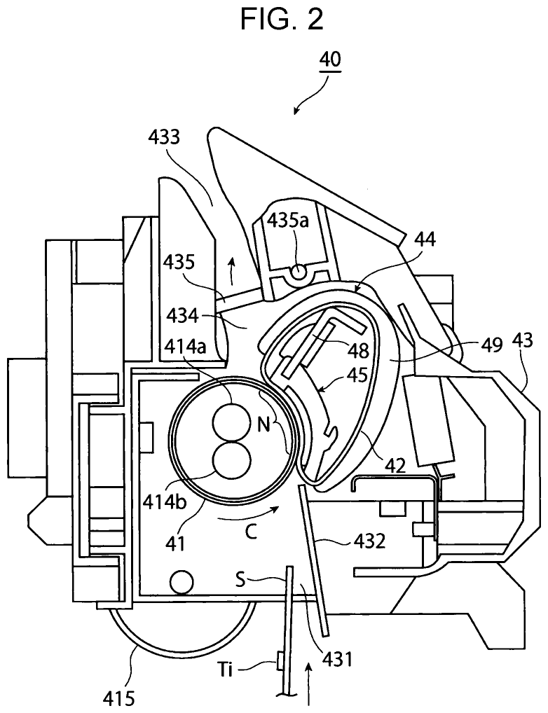

FIG. 2 is a sectional view of the fixing device 40 according to the first exemplary embodiment. The fixing device 40 according to the first exemplary embodiment is integrated as a fixing unit. As illustrated in FIG. 1, the fixing device 40 as a fixing unit is attachable and removable by opening and closing a rear cover 1b in both clockwise and counterclockwise directions, which is positioned on the right side in the figure with respect the apparatus body 1a of the image forming apparatus 1, in the clockwise direction.

As illustrated in FIG. 2, the fixing device 40 includes a device housing 43 as an example of a housing. The device housing 43 includes a frame (not shown) that supports the heating roller 41 and the pressing belt 42, a body (not shown) that holds the frame, an outer cover that covers the outer peripheries of the body and the frame, and the like. The heating roller 41 and the pressing belt 42 are disposed inside of the device housing 43 in a state of being pressed against each other. As described above, the pressing belt 42 is an example of an endless belt. The heating roller 41 is an example of a fixing section that forms the fixing nip N by being in contact with the pressing belt 42.

The device housing 43 has, in a lower end surface thereof, an inlet 431 through which the recording sheet 5, to which an unfixed toner image Ti has been transferred, is introduced to the inside thereof. Inside of the inlet 431, a guide plate 432, which guides the recording sheet 5 to the fixing nip N where the heating roller 41 and the pressing belt 42 are pressed against each other, is disposed in a state of being inclined diagonally upward. The device housing 43 has, in a left end portion of an upper end surface thereof, an outlet 433 through which the recording sheet 5, on which the heating roller 41 and the pressing belt 42 have performed a fixing operation, is discharged to the outside. In the outlet 433, an output roller (not shown) that discharges the recording sheet 5 to the outside of the device housing 43 is rotatably provided as appropriate. The recording sheet 5 is transported with reference to the center in the depth direction Y intersecting the transport direction (so-called center registration).

In a transport passage 434 formed between the fixing nip N and the outlet 433 of the fixing device 40, an actuator 435 having a bar-like shape is provided so as to be rotatable around a supporting point 435a in the clockwise direction. The actuator 435 is an example of a detector that detects passing of the leading end of the recording sheet 5. Rotational motion of the actuator 435 is detected as passing of the recording sheet 5 by an optical sensor (not shown) or the like.

As illustrated in FIG. 2, the fixing device 40 includes the heating roller 41 and a pressing unit 44 that holds the pressing belt 42 that is provided to be contactable with and separatable from the heating roller 41.

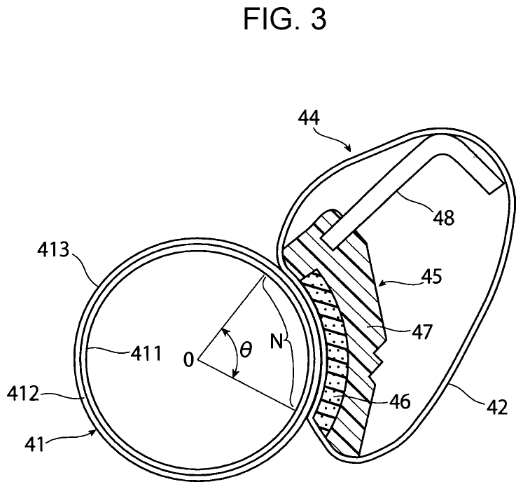

As illustrated in FIG. 3, the heating roller 41 includes a metal core 411 having a hollow cylindrical shape, an elastic body layer 412, and a release layer 413. The metal core 411 is made of a metal such as stainless steel, aluminum, or iron (thin high-tensile-strength steel pipe). The metal core 411 has a hollow cylindrical shape with a relatively small thickness and has a considerably small thermal capacity. The elastic body layer 412 is made of an elastic body that has heat resistance, such as a silicone rubber or a fluorocarbon resin rubber, and that covers the outer periphery of the metal core 411. The elastic body layer 412 also has a hollow cylindrical shape with a relatively small thickness, which contributes to reduction of the thermal capacity of the heating roller 41. The release layer 413 is a thin layer of polytetrafluoroethylene (PTFE), perfluoroalkoxy alkane (PFA), or the like that covers the surface of the elastic body layer 412. As illustrated in FIG. 2, two halogen lamps 414a and 414b (an example of a heater) are disposed inside of the heating roller 41. The two halogen lamps 414a and 414b are configured, for example, to have different heating regions extending in the depth direction Y perpendicular to the plane of the figure. The number of the halogen lamps 414a and 414b is not limited to two, and may be one, or three or more.

As illustrated in FIG. 2, both end portions of the heating roller 41 in the longitudinal direction (axial direction) thereof are rotatably supported inside of the device housing 43 via bearing members (not shown). The heating roller 41 is rotated with a desirable speed in the direction of an arrow C by a driving motor (not shown) on the apparatus body 1a side via a driving force transmitting gear 415 that meshes with a driving gear (not shown) attached to an end portion in the axial direction. The driving motor is an example of a driving source. The pressing belt 42 is rotated by being pressed against the heating roller 41, which is rotationally driven, in the fixing nip N.

The rotation speed of the heating roller 41, that is, the fixing speed may be adjustable to plural speeds, such as a high speed, a medium speed, and a low speed, in accordance with the basis weight, the material, and the like of the recording sheet 5.

The surface temperature of the heating roller 41 is detected by a temperature sensor (not shown). In the heating roller 41, energization of the halogen lamps 414a and 414b is controlled by a temperature control circuit, which includes a triac or the like (not shown), based on the detection result of the temperature sensor. As a result, the heating roller 41 is heated so that the surface thereof has a desirable fixing temperature.

As illustrated in FIG. 2, the pressing unit 44 includes the pressing belt 42, a pressing member 45 (an example of a pressing section), a metal plate member 48, a pair of guide members 49, a slide sheet (not shown), a felt member (not shown), and the like. As illustrated in FIG. 3, the pressing member 45 includes an clastic member 46 and a holding member 47 that is disposed inside of the pressing belt 42 and that holds the clastic member 46 to press the pressing belt 42 against the heating roller 41. The metal plate member 48 is an example of an attachment section that attaches the holding member 47 of the pressing member 45 in a fixed state. The pair of guide members 49 is an example of a guide section that is disposed in a state in which both end portions thereof in the longitudinal direction of the metal plate member 48 are fixed and that rotatably guides the pressing belt 42. The slide sheet (not shown) is an example of a sheet that is interposed between the pressing belt 42 and the pressing member 45 and that reduces sliding resistance. The felt member (not shown) is an example of a lubricant holding section that is disposed inside of the pressing belt 42 and that holds a lubricant to be applied to the inner peripheral surface of the pressing belt 42.

The pressing belt 42 is an endless belt that is made of a flexible material and whose free shape before being attached is a thin hollow cylindrical shape. The pressing belt 42 includes a base layer, an elastic body layer that covers the surface of the base layer, and a release layer that covers the surface of the elastic body layer. Alternatively, the pressing belt 42 may include a base layer and a release layer that directly covers the surface of the base layer. The base layer is made of a synthetic resin having heat resistance, such as polyimide, polyamide, or polyimideamide, or a metal, such as stainless steel, nickel, or copper. The elastic body layer is made of an elastic material having heat resistance, such as a silicone rubber or a fluorocarbon resin rubber. The release layer is made of polytetrafluoroethylene (PTFE), perfluoroalkoxy alkane (PFA), or the like. The thickness of the pressing belt 42 can be set, for example, in the range of about 50 to 200 μm.

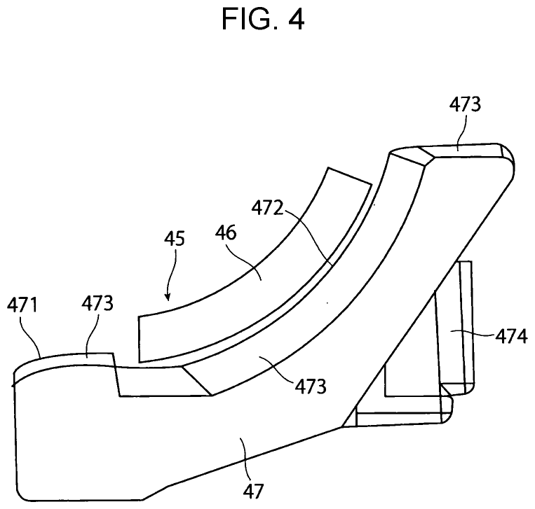

As described above, the pressing member 45 includes the elastic member 46 and the holding member 47 that is disposed inside of the pressing belt 42 and that holds the elastic member 46 to press the pressing belt 42 against the heating roller 41 in the entire region of the fixing nip N. As illustrated in FIGS. 3 and 4, the holding member 47 is a member that holds the elastic member 46 to press the pressing belt 42 toward the surface of the heating roller 41 in the region of the fixing nip N.

The metal plate member 48 is formed by, for example, bending a plate made of a metal such as stainless steel, aluminum, or iron. Although the example illustrated in the figure has only one metal plate member 48, in addition to the metal plate member 48, another metal plate member may be disposed parallel to the metal plate member 48. The metal plate member 48 attaches the holding member 47 of the pressing member 45 in a fixed state, and thereby determines the direction in which the holding member 47 is pressed against the outer peripheral surface of the heating roller 41. The direction in which the holding member 47 is pressed against the outer peripheral surface of the heating roller 41 is set, for example, to a direction toward the center O of the heating roller 41.

A felt member (not shown) is provided on the outer surface of the metal plate member 48 over the entire length by using an adhesive or the like. The felt member has a comparatively large thickness so that the felt member can elastically deform to support the pressing belt 42 when a tension is applied to the pressing belt 42.

The felt member is impregnated with a predetermined amount of lubricant that is to be applied to the inner peripheral surface of the pressing belt 42. As the lubricant, for example, amino modified silicone oil having a viscosity in the range of 100 to 350 cs or the like is used. The felt member is impregnated with the lubricant beforehand, and thereby the lubricant is applied to the inner peripheral surface of the pressing belt 42. However, this is not a limitation, and the lubricant may be supplied in a state of being initially applied to the inner peripheral surface of the pressing belt 42.

The slide sheet (not shown) is an elongated flat rectangular sheet. As the slide sheet, for example, a sheet including a base layer and a texture of fabric, knit, and the like that is stacked on the front surface or on the front and back surfaces of the base layer is used. The base layer is made of a fluorocarbon resin such as polytetrafluoroethylene (PTFE). The texture of fabric, knit, and the like is made of glass fiber, aramid fiber, and the like. The slide sheet may have only a single layer of fabric, knit, or the like made of glass fiber, aramid fiber, or the like. The thickness of the slide sheet may be set in the range of about 100 to 200 μm.

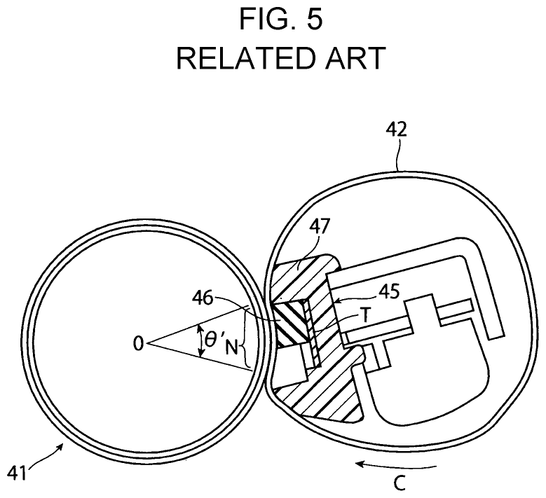

As illustrated in FIG. 5, in a fixing device 40 of the related art, in order to press a pressing belt 42 against the outer peripheral surface of the heating roller 41 in a fixing nip N, an elastic body that is made of a silicone rubber or the like having a rectangular sectional shape and held by the holding member 47 is used as an elastic member 46. The elastic body made of a silicone rubber or the like is vulcanized and fixed to a surface of a metal plate member T made of a thin stainless-steel plate or the like in consideration of workability or the like when causing the clastic body to be held by the holding member 47.

Therefore, the fixing device 40 of the related art has a technical problem in that the manufacturing cost of a pressing body inevitably increases in order to achieve low-surface-pressurization by reducing the pressure with which the pressing belt 42 is pressed against the outer peripheral surface of the heating roller 41, because it is necessary to strictly control the elasticity and the relationship between the thickness, the width, and the like of the elastic member 46 that determine the amount of deformation (the amount of bite) due to pressing of the elastic member 46.

Thus, a fixing device according to the present exemplary embodiment includes a pressing section that is disposed inside of a belt, that holds an elastic member to press the belt against a fixing section, and that is disposed in a shape such that the elastic member in a state of not being pressed against the fixing section follows the outer peripheral shape of the fixing section in a fixing nip.

That is, as illustrated in FIGS. 3 and 4, the fixing device 40 according to the first exemplary embodiment includes the pressing member 45 as an example of a pressing section that is disposed inside of the pressing belt 42 and that holds the elastic member 46 to press the pressing belt 42 against the heating roller 41.

As described above, the pressing member 45 includes the elastic member 46 and the holding member 47 that is disposed inside of the pressing belt 42 and that holds the elastic member 46 to press the pressing belt 42 against the heating roller 41. As illustrated in FIGS. 3 and 4, the holding member 47 is a member that holds the clastic member 46 to press the pressing belt 42 against the surface of the heating roller 41 in the region of the fixing nip N.

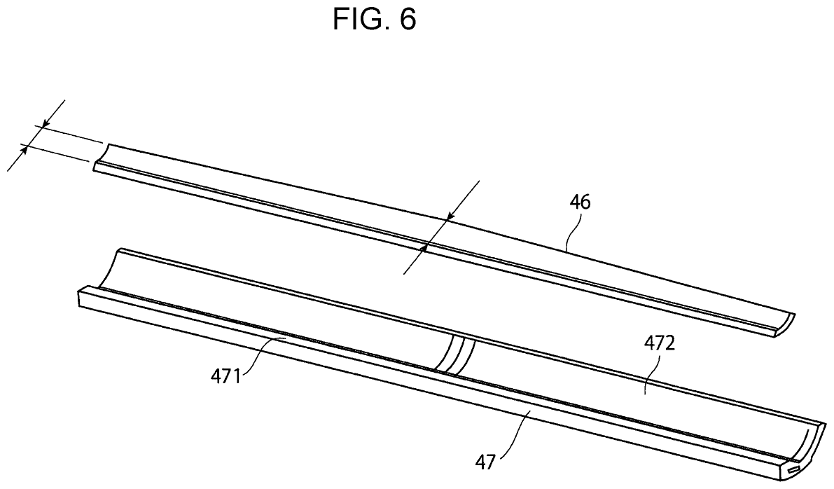

The clastic member 46 is made of, for example, a foam of silicone rubber, EPDM, or the like having heat resistance. As illustrated in FIG. 6, as the elastic member 46, for example, a sheet-shaped member having a uniform thickness and cut to have desirable width and length is used as it is.

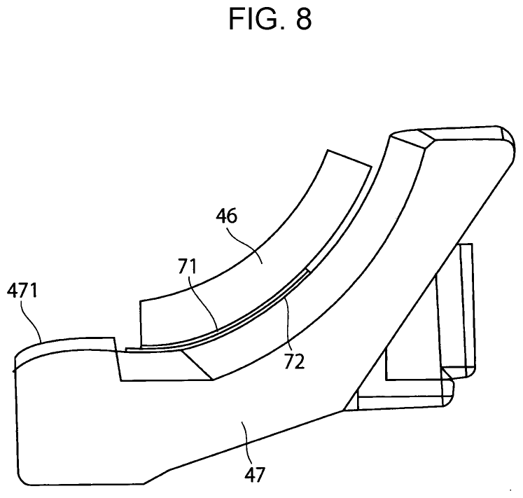

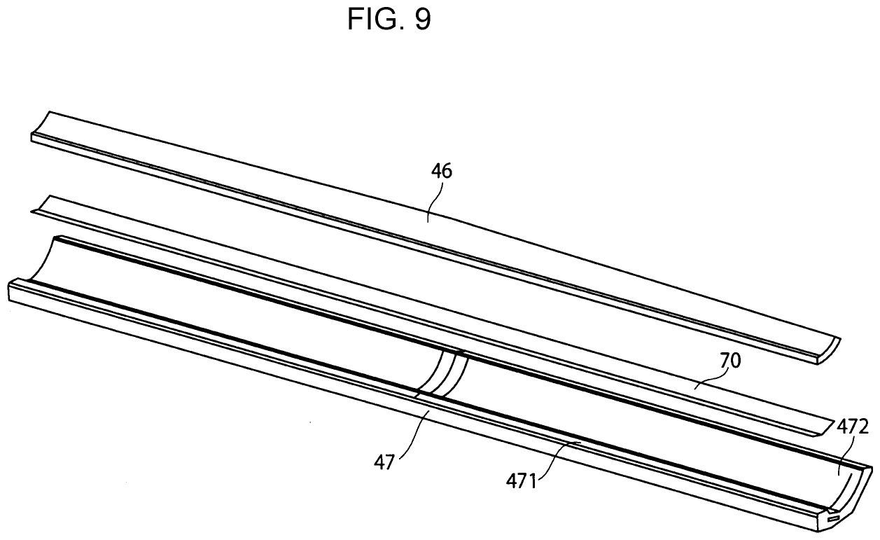

As the elastic member 46, silicone sponge, which is a foam of silicone rubber, is used. The elastic member 46 is not bonded to a metal plate, and a member having a strip-like shape is used as it is. However, as illustrated in FIGS. 8 and 9, one or more sheet-shaped members 70 to 72 may be interposed between the elastic member 46 and the holding member 47 in order to fix the clastic member 46 at a desirable position on the holding member 47 and to adjust pressure.

In the present exemplary embodiment, when the thickness of the elastic member 46 is 3 mm, the elastic member 46 has a tensile strength of 1.0 MPa, an extension of 50 to 70%, a 25% compressive load of 0.03 MPa, and a compressive residual strain of 5.0%.

The holding member 47 is made of, for example, a heat-resistant synthetic resin or the like that is integrally formed into a desirable sectional shape by injection molding or the like. Examples of a heat-resistant synthetic resin include liquid crystal polymer (LCP), polyetheretherketone (PEEK), polyphenylene sulfide (PPS), polyether sulfone (PES), polyamideimide (PAI), polytetrafluoroethylene (PTFE), polychlorotrifluoroethylene (PCTFE), polyvinylidene fluoride (PVDF), and a composite of any of these.

As illustrated in FIG. 4 (side view) and in FIG. 6, in an exit portion of the fixing nip N, the holding member 47 includes a pressing portion 471 that is directly pressed against the surface of the heating roller 41 without the elastic member 46 therebetween. The sectional shape of the pressing portion 471 is a substantially planar shape whose end portion on the exit side of the fixing nip N is curved or a shape in which the fixing nip N is convexly curved toward the heating roller 41 side.

As illustrated in FIG. 4, a portion 472 of the holding member 47 positioned further on the upstream side of the fixing nip N than the pressing portion 471 has a shape that follows the outer peripheral shape of the heating roller 41 in the fixing nip N, that is, a substantially arc shape that is concavely curved toward the heating roller 41 side. Here, the portion 472 of the holding member 47 positioned further on the upstream side of the fixing nip N than the pressing portion 471 need not have an arc shape that precisely follows the outer peripheral shape of the heating roller 41, and may include a flat part or a curved part whose curvature differs from that of the arc of the heating roller 41. A portion 473 illustrated in FIG. 4 is a chamfered portion that is formed at an end portion of the holding member 47 in the longitudinal direction. A portion 474 is an attachment portion of a second metal plate member (not shown) fixed to the holding member 47.

The portion 472 of the holding member 47, which is positioned further on the upstream side of the fixing nip N than the pressing portion 471, is formed as a pressure adjusting surface as an example of a holding portion that holds the elastic member 46 to adjust pressure applied to the heating roller 41. The pressure adjusting surface 472 is disposed at a position separated farther than the pressing portion 471 from the outer peripheral surface of the heating roller 41.

The pressure adjusting surface 472 of the holding member 47 holds the elastic member 46. As illustrated in FIG. 4, when the clastic member 46 held by the holding member 47 is not pressed against the heating roller 41, the elastic member 46 is disposed in a substantially arc shape that follows the outer peripheral shape of the heating roller 41 in the fixing nip N.

That is, the pressure adjusting surface 472 of the holding member 47 not only has a function of holding the clastic member 46 but also has a function of adjusting the pressure against the heating roller 41 in at least one of the axial direction of the heating roller 41 and a direction intersecting the axial direction by allowing partial deformation of the elastic member 46 in the thickness direction.

As illustrated in FIG. 6, the pressure adjusting surface 472, for example, holds the elastic member 46, which has a sheet-like shape having a uniform thickness, to cause the elastic member 46 to elastically deform in the thickness direction and thereby generate a pressure in the fixing nip N. The pressure generated by clastic deformation of the elastic member 46 is basically determined by the elastic modulus of the material of the clastic member 46 and the elastic deformation amount of the clastic member 46.

By appropriately adjusting the shape of the pressure adjusting surface 472 of the holding member 47 in the longitudinal direction thereof and a direction that intersects the longitudinal direction, it is possible to adjust the pressure generated by elastic deformation of the elastic member 46 to be in an appropriate state in the longitudinal direction thereof and a direction that intersects the longitudinal direction.

The pressure adjusting surface 472 of the holding member 47 may be a curved surface or a curved surface including a flat surface in a part thereof. The pressure adjusting surface 472 of the holding member 47 may include a surface including at least one of unevenness, a slit, and a hole.

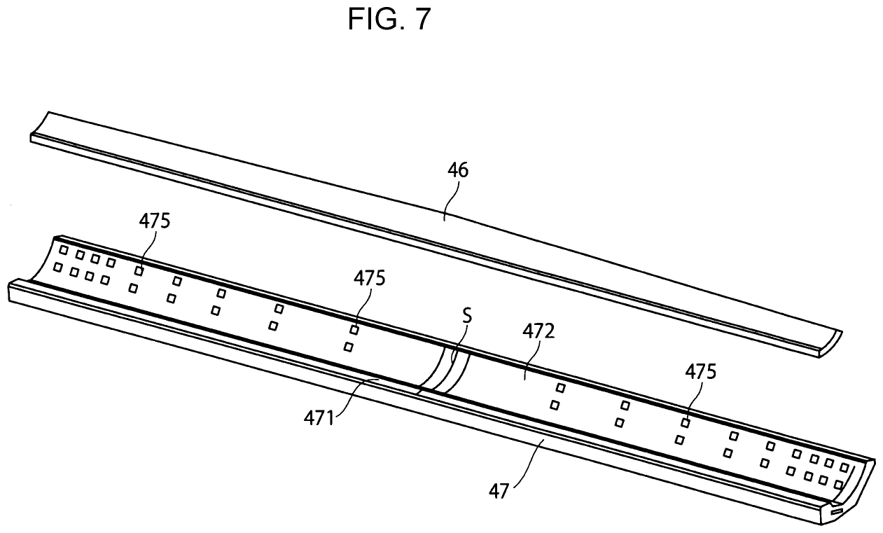

As illustrated in FIG. 7, the pressure adjusting surface 472 of the holding member 47, for example, has small recesses 475 each having a rectangular shape or a circular shape in a plan view. The recesses 475 are formed as holes, through-holes, or the like that are recessed from the pressure adjusting surface 472. The recesses 475 are arranged in the longitudinal direction of the holding member 47 and in the width direction intersecting the longitudinal direction.

The recesses 475 are arranged, in the longitudinal direction of the holding member 47, symmetrically on both sides with respect to the center S in a direction intersecting the transport direction of the recording sheet 5 in such a way that the distance therebetween gradually decreases toward end portions. The recesses 475 are arranged in two rows only on the entrance side of the fixing nip N in a direction that intersects the longitudinal direction of the holding member 47. Since both end portions of the holding member 47 in the longitudinal direction are supported by the frame (not shown) of the device housing 43 via the metal plate member 48, pressure against the heating roller 41 at both end portions tends to be large compared with that at a middle portion. Thus, by arranging the recesses 475 in such a way that the distance therebetween gradually decreases in the longitudinal direction of the holding member 47 toward both end portions, it is possible to make the pressure at both end portions in the longitudinal direction of the holding member 47 less than that at the middle portion, and, as a result, it is possible to make pressure uniform in the longitudinal direction of the holding member 47.

The arrangement of the recesses 475 is not limited to this and may be any appropriate arrangement. By appropriately arranging the recesses 475, it is possible to set pressure to be generated due to deformation of the elastic member with high degree of freedom. Instead of the recesses, unevenness, slits, holes, or the like may be used.

The recesses 475 of the holding member 47 partially reduce the area of a part of the pressure adjusting surface 472 that supports the back surface of the elastic member 46. The recesses 475 may have any appropriate depth, may be in a non-contact state of not contacting the back surface of the elastic member 46 at all, or may be in a contact state of contacting the back surface when the elastic member 46 deforms to a certain degree.

As illustrated in FIG. 3, in the first exemplary embodiment, the fixing nip N, where the holding member 47 holds the elastic member 46 to press the pressing belt 42 against the heating roller 41, has a comparatively large area compared with that in the fixing device of the related art.

That is, the holding member 47 has a relatively large center angle θ close to about 90 degrees over the outer periphery of the heating roller 41. As illustrated in FIG. 5, a fixing device 40 that is an equivalent in the related art has a very small center angle θ′, and an example of the length of the fixing nip N along the outer periphery of the heating roller 41 is about 8 mm. In contrast, as illustrated in FIG. 3, in the fixing device 40 according to the first exemplary embodiment, an example of the length of the fixing nip N along the outer periphery of the heating roller 41 is about 15 mm, which is about twice the above.

The center angle θ of the fixing nip N, where the holding member 47 holds the elastic member 46 to press the elastic member 46 against the outer peripheral surface of the heating roller 41, is desirably greater than or equal to 45 degrees and more desirably in the range of 60 degrees to 90 degrees.

The center angle θ with which the holding member 47 forms the fixing nip N corresponds to the area of the fixing nip N when it is assumed that the length in the axial direction over which the pressing belt 42 is pressed against the surface of the heating roller 41 is the same. When the center angle θ of the holding member 47 is twice that in the related art, if the total pressure between the pressing belt 42 and the heating roller 41 is constant, it is possible to halve the pressure per unit area with which the holding member 47 presses the pressing belt 42 against the heating roller 41, and it is possible to achieve low-pressurization. Low-pressurization of the holding member 47 also contributes to reduction in the thickness of the metal core 411 and the elastic body layer 412 of the heating roller 41.

### Effects of Fixing Device

Due to the configuration described above, with the fixing device according to the first exemplary embodiment, it is possible to enable a sheet-shaped member having a uniform thickness to be used as the elastic member as follows, and it is possible to achieve reduction in manufacturing cost compared with a case where a sheet-shaped member having a non-uniform thickness is used.

That is, as illustrated in FIG. 3, in the fixing device 40 according to the first exemplary embodiment, the elastic member 46 in the pressing member 45, which presses the pressing belt 42 against the surface of the heating roller 41, has a substantially arc shape that follows the outer peripheral shape of the heating roller 41 in a state of not being pressed against the surface of the heating roller 41.

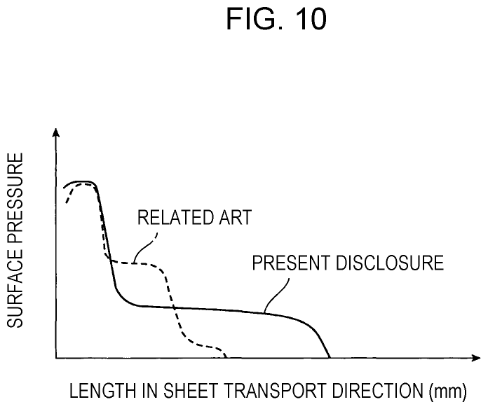

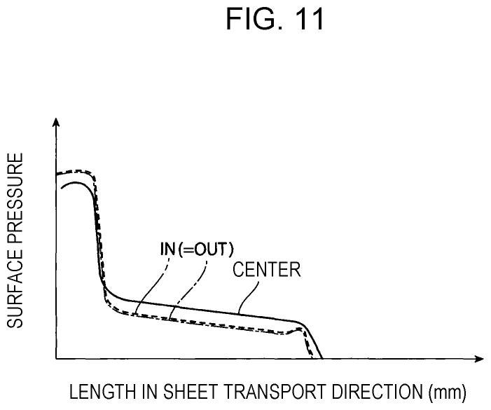

Therefore, in the fixing device 40, it is possible to use, as the elastic member 46, a sheet-shaped low-density silicone foam or the like having a uniform thickness. As illustrated in FIGS. 10 and 11, in contrast to an elastic member made of a silicone rubber or the like, the elastic member 46 made of a low-density silicone foam or the like has a low clastic modulus, and, even when the thickness is reduced to achieve low-pressurization, it is possible to achieve a desirable low surface-pressure with high precision and with ease by, for example, controlling the shape of the pressure adjusting surface 472 of the holding member 47, providing the recesses 475 in the pressure adjusting surface 472, and controlling the thickness of the elastic member 46.

Thus, it is possible to avoid increase in the cost of the fixing device 40 due to increase in the manufacturing cost of the elastic member 46 or the like.

Although an application to a full color image forming apparatus has been described in the exemplary embodiment, it is clear that the present disclosure is applicable to a monochrome image forming apparatus in the same way.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A fixing device comprising:

an endless belt;

a fixing section that forms a fixing nip by being in contact with the belt; and

a pressing section that includes a holding portion that is disposed inside of the belt, has a shape following an outer peripheral shape of the fixing section, and holds an elastic member, the pressing section pressing the belt against the fixing section,

wherein the elastic member has a shape along the holding portion due to deformation in a state of not being pressed against the fixing section.

(((2)))

The fixing device according to (((1))), wherein the holding portion of the pressing section is formed as a pressure adjusting surface that has a curved surface shape and that adjusts pressure against the fixing section.

(((3)))

The fixing device according to (((2))), wherein the pressure adjusting surface adjusts the pressure by allowing partial deformation of the elastic member in a thickness direction.

(((4)))

The fixing device according to (((3))), wherein the pressure adjusting surface includes a surface including at least one of unevenness, a slit, and a hole.

(((5)))

The fixing device according to (((1))), wherein the elastic member includes a foam made of silicone.

(((6)))

The fixing device according to (((5))), wherein the pressing section includes a pressing portion that is made of a synthetic resin and that directly presses the belt against the fixing section in a downstream end portion thereof in a rotation direction of the belt.

(((7)))

The fixing device according to (((1))), wherein the fixing section includes a heating roller having a heater therein.

(((8)))

The fixing device according to (((7))), wherein the pressing section presses the belt against the heating roller over an entire region of the fixing nip.

(((9)))

An image forming apparatus comprising:

an image forming unit that forms an image on a recording medium; and

a fixing unit that fixes the image to the recording medium,

wherein the fixing device according to any one of (((1))) to (((8))) is used as the fixing unit.

What is claimed is:

1. A fixing device comprising:
an endless belt;
a fixing section that forms a fixing nip by being in contact with the belt; and
a pressing section that includes a holding portion that is disposed inside of the belt, has a shape following an outer peripheral shape of the fixing section, and holds an elastic member, the pressing section pressing the belt against the fixing section,
wherein the elastic member has a shape along the holding portion due to deformation in a state of not being pressed against the fixing section.

2. The fixing device according to claim 1, wherein the holding portion of the pressing section is formed as a pressure adjusting surface that has a curved surface shape and that adjusts pressure against the fixing section.

3. The fixing device according to claim 2, wherein the pressure adjusting surface adjusts the pressure by allowing partial deformation of the elastic member in a thickness direction.

4. The fixing device according to claim 3, wherein the pressure adjusting surface includes a surface including at least one of unevenness, a slit, and a hole.

5. The fixing device according to claim 1, wherein the elastic member includes a foam made of silicone.

6. The fixing device according to claim 5, wherein the pressing section includes a pressing portion that is made of a synthetic resin and that directly presses the belt against the fixing section in a downstream end portion thereof in a rotation direction of the belt.

7. The fixing device according to claim 1, wherein the fixing section includes a heating roller having a heater therein.

8. The fixing device according to claim 7, wherein the pressing section presses the belt against the heating roller over an entire region of the fixing nip.

9. An image forming apparatus comprising:
an image forming unit that forms an image on a recording medium; and
a fixing unit that fixes the image to the recording medium,
wherein the fixing device according to claim 1 is used as the fixing unit.

10. An image forming apparatus comprising:
an image forming unit that forms an image on a recording medium; and
a fixing unit that fixes the image to the recording medium,
wherein the fixing device according to claim 2 is used as the fixing unit.

11. An image forming apparatus comprising:
an image forming unit that forms an image on a recording medium; and
a fixing unit that fixes the image to the recording medium,
wherein the fixing device according to claim 3 is used as the fixing unit.

12. An image forming apparatus comprising:
an image forming unit that forms an image on a recording medium; and
a fixing unit that fixes the image to the recording medium,
wherein the fixing device according to claim 4 is used as the fixing unit.

13. An image forming apparatus comprising:
an image forming unit that forms an image on a recording medium; and
a fixing unit that fixes the image to the recording medium,
wherein the fixing device according to claim 5 is used as the fixing unit.

14. An image forming apparatus comprising:
an image forming unit that forms an image on a recording medium; and
a fixing unit that fixes the image to the recording medium,
wherein the fixing device according to claim 6 is used as the fixing unit.

15. An image forming apparatus comprising:
an image forming unit that forms an image on a recording medium; and
a fixing unit that fixes the image to the recording medium,
wherein the fixing device according to claim 7 is used as the fixing unit.

16. An image forming apparatus comprising:
an image forming unit that forms an image on a recording medium; and
a fixing unit that fixes the image to the recording medium,
wherein the fixing device according to claim 8 is used as the fixing unit.

17. A fixing device comprising:
an endless belt;
fixing means for forming a fixing nip by being in contact with the belt; and
pressing means for pressing the belt against the fixing means, the pressing means including a holding portion being disposed inside of the belt, having a shape following an outer peripheral shape of the fixing means, and holding an elastic member,
wherein the elastic member has a shape along the holding portion due to deformation in a state of not being pressed against the fixing means.
